(19) United States
(12) Patent Application Publication
(10) Pub. No.: US 2016/0322141 A1
(43) Pub. Date: Nov. 3, 2016

(54) NICKEL-ZINC FERRITES AND METHODS FOR PREPARING SAME USING FINE IRON OXIDE AND BAG HOUSE DUST

(71) Applicant: SABIC GLOBAL TECHNOLOGIES BV, Amsterdam (NL)

(72) Inventors: Fazal-ur-Rehman Awan, Al-Jubail (SA); Mahmoud Mohamed Hessien, Taif (SA); Hesham Hanafy, Al-Jubail (SA)

(21) Appl. No.: 15/108,422

(22) PCT Filed: Jan. 13, 2015
(86) PCT No.: PCT/IB2015/050255

§ 371 Date: Jun. 27, 2016

Related U.S. Application Data
(60) Provisional application No. 61/928,686, filed on Jan. 17, 2014.

(51) Int. Cl. H01F 1/34; C01G 53/00; C01G 49/00

(52) U.S. Cl. CPC H01F 1/344; C01G 49/0063; C01G 53/40; C01P 2006/42; C01P 2002/30

(57) ABSTRACT

Method for preparing soft cubic ferrites of a general formula M^{a}₍₁₋ᵢ₎M^{b}ᵢFe₂O₄ comprising the steps of contacting an iron source a first metal oxide having the general formula M^{b}ₓO_{y} and a second metal oxide having the general formula M^{a}ₓO_{y} to form a mixture, wherein the stoichiometric ratio of (M^{a}+M^{b}) to iron is in the range from greater than zero to about 2, and wherein M^{a} and M^{b} comprise nickel, magnesium, zinc, or a combination thereof; and calcining the mixture at a temperature range of from about 1000° C. to about 1500° C. in a static air atmosphere, to form a soft cubic ferrite of a general formula M^{a}_{(1-I)}M^{b}ᵢFe₂O₄, wherein the mixture is not subjected to an oxidation step or a reduction step prior calcining.

### BACKGROUND

1. Technical Field

The present disclosure relates to nickel-zinc ferrite materials and to methods for the preparation thereof.

2. Technical Background

Ferromagnetic oxides, or ferrites as they are frequently known, can be useful as high-frequency magnetic materials due to their large resistivities. Ferrites have become available as practical magnetic materials over the course of the last twenty years. Such ferrites are frequently used in communication and electronic engineering applications and they can embrace a very wide diversity of compositions and properties. Ferrites are ceramic materials, typically dark grey or black in appearance and very hard or brittle. Ferrite cores can be used in electronic inductors, transformers, and electromagnets where high electrical resistance leads to low eddy current losses. Early computer memories stored data in the residual magnetic fields of ferrite cores, which were assembled into arrays of core memory. Ferrite powders can be used in the coatings of magnetic recording tapes. Ferrite particles can be used as a component of radar-absorbing materials in stealth aircrafts and in the expensive absorption tiles lining the rooms used for electromagnetic compatibility measurements. Moreover, common radio magnets, including those used in loudspeakers, can be ferrite magnets. Due to their price and relatively high output, ferrite materials can also be used for electromagnetic instrument pickups.

There are basically two varieties of ferrite: soft (cubic ferrites) and hard (hexagonal ferrites) magnetic applications. Soft ferrites are characterized by the chemical formula MOFe₂O₃, with M being a transition metal element, e.g. iron, nickel, manganese or zinc. Hard ferrites are permanent magnetic materials based on the crystallographic phases BaFe₁₂O₁₉, SrFe₁₂O₁₉, and PbFe₁₂O₁₉. The formulas for these hard ferrite materials can generally be written as MFe₁₂O₁₉, where M can be Ba, Sr, or Pb. The soft ferrites belong to an important class of magnetic materials because of their remarkable magnetic properties particularly in the radio frequency region, physical flexibility, high electrical resistivity, mechanical hardness, and chemical stability.

Soft ferromagnetic oxides (ferrites) can be useful as high-frequency magnetic materials. The general formula for these compounds is MOFe₂O₃ or MFe₂O₄, where M can be a divalent metallic ion such as Fe²⁺, Ni²⁺, cu²⁺, Mg²⁺, Mn²⁺, Zn²⁺, or a mixture thereof. Soft ferrites can be useful in a broad range of electronic applications in including television deflection yokes and flyback transformers, rotary transformers in video players and recorders, switch-mode power supplies, EMI-RFI (Electromagnetic Interference and Radio Frequency Interference) absorbing materials, and a wide variety of transformers, filters and inductors in electronic home appliances and industrial equipment. A soft ferrite core can exhibit high magnetic permeability which concentrates and reinforces the magnetic field and high electrical resistivity, thus limiting the amount of electric current flowing in the ferrite. Many telecommunication parts, power conversion and interference suppression devices use soft ferrites. Frequently used combinations include manganese and zinc (MnZn) or nickel and zinc (NiZn). These compounds exhibit good magnetic properties below a certain temperature, called the Curie Temperature (Tc). They can easily be magnetized and have a rather high intrinsic resistivity.

Accordingly, there is an ongoing need for new, economical, environmentally friendly, and effective ferrite materials and methods for preparing such ferrite materials. Thus, there is a need to address these and other shortcomings associated with ferrite materials. These needs and other needs are satisfied by the compositions and methods of the present disclosure.

### SUMMARY

In accordance with the purpose(s) of the invention, as embodied and broadly described herein, this disclosure, in one aspect, relates to nickel ferrite materials and methods for the preparation thereof.

In one aspect, the present disclosure provides a method for preparing soft cubic ferrites of a general formula M^{a}₍₁₋ᵢ₎M^{b}ᵢFe₂O₄ comprising contacting an iron source; a first metal oxide having the general formula M^{b}ₓO_{y}; and a second metal oxide having the general formula M^{a}ₓO_{y}; wherein metals M^{a} and M^{b} comprise nickel, magnesium, zinc, or a combination thereof; and wherein the stoichiometric ratio of M^{a}/M^{b} is equal to i/(1−i); mixing the iron source, the first metal oxide, and the second metal oxide to form a mixture, wherein the stoichiometric ratio of (M^{a}+M^{b}) to iron is from greater than zero to about 2; and then calcining the mixture at the temperature range from about 1,000° C. to about 1,500° C. in a static air atmosphere; wherein the mixture is not subjected to an oxidation step or a reduction step prior calcining.

In another aspect, the present disclosure provides methods as described above, wherein M^{a} is nickel and/or wherein M^{b} is zinc

In another aspect, the present disclosure provides methods for preparing nickel zinc ferrites wherein an iron source comprises iron containing by-products of iron ore processing and/or bag house dust.

In another aspect, the present disclosure provides nickel zinc ferrite materials prepared by the methods described herein.

In yet another aspect, the present disclosure provides articles and/or devices comprising the nickel zinc ferrite materials described herein.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates the XRD pattern for bag house dust.

FIG. 2 illustrates an exemplary process diagram for the synthesis of Ni_{0.8}Zn_{0.2}Fe₂O₄ materials using a conventional solid state reaction method.

FIG. 3 illustrates the XRD pattern for a Ni_{0.8}Zn_{0.2}Fe₂O₄ powder prepared from fine iron oxide and bag house dust at (0.8Ni+0.2Zn):Fe=1:2.

FIG. 4 illustrates the XRD pattern for a Ni_{0.8}Zn_{0.2}Fe₂O₄ powder prepared from fine iron oxide and bag house dust at (0.8Ni+0.2Ni):Fe=1:1.9.

FIG. 5 illustrates the XRD pattern for a Ni_{0.8}Zn_{0.2}Fe₂O₄ powder prepared from fine iron oxide and bag house dust at (0.8Ni+0.2Ni):Fe=1:1.8.

FIG. 6 illustrates scanning electron micrographs (SEM) of crystalline Ni_{0.8}Zn_{0.2}Fe₂O₄ powders prepared from fine iron oxide and bag house dust at 1,300° C.

FIG. 7 illustrates microstructure maps for elemental constituents in a Ni_{0.8}Zn_{0.2}Fe₂O₄ powder prepared from fine iron oxide and bag house dust at (0.8Ni+0.2Zn):Fe=1:1.9 and annealed at 1,300° C.

FIG. 8 illustrates Energy Dispersive X-Ray (EDX) spot analysis of Ni_{0.8}Zn_{0.2}Fe₂O₄ powder prepared from fine iron oxide and bag house dust at (0.8Ni+0.2Zn):Fe=1:1.9 and annealed at 1,300° C.

FIG. 9 illustrates the effect of annealing temperature on the M-H hysteresis loop of Ni_{0.8}Zn_{0.2}Fe₂O₄ powder prepared from fine iron oxide and bag house dust at (0.8Ni+0.2Zn):Fe=1:2.

FIG. 10 illustrates the effect of annealing temperature on the M-H hysteresis loop of Ni_{0.8}Zn_{0.2}Fe₂O₄ powder prepared from fine iron oxide and bag house dust at (0.8Ni+0.2Zn):Fe=1:1.9.

FIG. 11 illustrates the effect of annealing temperature on the M-H hysteresis loop of Ni_{0.8}Zn_{0.2}Fe₂O₄ powder prepared from fine iron oxide and bag house dust at (0.8Ni+0.2Zn):Fe=1:1.8.

All publications mentioned herein are incorporated herein by reference to disclose and describe the methods and/or materials in connection with which the publications are cited.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a ketone” includes mixtures of two or more ketones.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

References in the specification and concluding claims to parts by weight of a particular element or component in a composition or article denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides improved soft ferrite materials and methods for the manufacture thereof. In one aspect, the methods described herein can utilize by-products from conventional steel industry processes as raw materials in the preparation of soft ferrite materials. In one aspect, such by-products can comprise an iron source and contain, in various aspects, high iron content, low impurities, and/or stable chemical compositions. In another aspect, a by-product can comprise a fine iron oxide dust or pellets comprising the same. In another aspect, such by-products can be contacted and/or mixed with one or more other metal oxide materials and be subsequently heat treated at various temperatures. In another aspect, the by-products can comprise a bag house dust that can contain metal and/or metal containing compounds. In one aspect, the methods described herein can be environmentally friendly, at least with respect to conventional ferrite production methods, by incorporating by-products from iron ore processing or steel industry processes.

In one aspect, nickel-zinc (Ni—Zn) ferrites can be useful in biomedicine as magnetic carriers, for example, in bioseparation, enzyme and protein immobilization. In another aspect, a Ni—Zn ferrite, the addition of nonmagnetic zinc ferrite to the inverse spinel Ni ferrite can improve the saturation magnetization. Zinc ferrite, ZnFe₂O₄, is a normal spinel, and as such the unit cell has no net magnetic moment (ZnFe₂O₄/Zn²⁺[Fe³⁺Fe³⁺]O₄/d⁰[d⁵d⁵]). Nickel ferrite is an inverse spinel and, consequently, the two magnetic sublattices are anti-ferromagnetically aligned. (NiFe₂O₄/Fe³⁺[Ni²⁺Fe³⁺]O₄/d⁵[d⁵d⁵]). When a nonmagnetic zinc ion (d¹⁰) is substituted into the Ni ferrite lattice, it has a stronger preference for the tetrahedral site than does the ferric ion and thus reduces the amount of Fe³⁺ on the A site. As a result of the antiferromagnetic coupling, the net result can be an increase in magnetic moment on the B lattice and an increase in saturation magnetization (Znₓ²⁺Fe₁₋ₓ³⁺[Ni²⁺Fe³⁺]O₄/dₓ¹⁰d₍₁₋ₓ₎⁵[d⁵d⁵]); however, the change in magnetic properties of Ni—Zn ferrites can depend on the solubility of cations (Ni²⁺ or Zn²⁺) in the ferrite lattice and occupying the positions of tetrahedral or octahedral sites. According to their structure, Ni—Zn ferrites can have a tetrahedral A site and an octahedral B site in an AB₂O₄ crystal structure. Various magnetic properties thus depend on the composition and cation distribution. In one aspect, various cations can be placed in A and B sites to tune the magnetic properties. While not wishing to be by theory, the antiferromagnetic A-B superexchange interaction can be the main cause of cooperative behavior of magnetic dipole moments in the ferrites, which is observed in Ni—Zn ferrites below their Curie temperature.

In one aspect, the soft ferrite can comprise a soft ferrite, such as, for example, a nickel ferrite, a magnesium ferrite, a zinc ferrite, or a combination thereof. In one aspect, the soft ferrite can comprise a nickel zinc ferrite. In another aspect, one or more of the raw materials used in the preparation of a soft ferrite can comprise a by-product of iron ore processing, such as, for example, a fine iron oxide dust. In another aspect, the iron containing by-product can comprise, for example, oxide pellet fines from iron ore processing. In another aspect, one or more of the raw materials used in the preparation of a soft ferrite can comprise a source of metal(s) other than iron. In one aspect, such a raw material can comprise, for example, bag house dust. In one aspect, two or more raw materials originating from an industrial process, such as, for example, an iron ore or steel production process can be used. In such an aspect, at least one raw material can comprise an iron containing source, such as, for example, a fine iron oxide dust, and at least one other raw material can comprise a bag house dust. In other aspects, raw materials can comprise a combination of by-products and/or commercially sourced (e.g., analytical grade) components.

The raw materials for preparing a soft ferrite material can comprise or be prepared from an iron oxide, such as for example, a fine iron oxide dust, a bag house dust, and optionally a metal oxide, such as, for example, a zinc, magnesium, and/or nickel oxide. In one aspect, the soft ferrite material comprises or can be prepared from an iron oxide, a zinc oxide, and a nickel oxide. In still other aspects, the nickel and/or zinc oxide can initially be provided in a form other than the oxide, such that the nickel and/or zinc containing compound can be converted to an oxide prior to or during formation of the desired ferrite material.

In one aspect, an iron containing by-product can comprise an iron oxide dust, mill scale, bag house dust, or a combination thereof. In one aspect, the iron containing by-product can comprise any suitable iron containing material. In another aspect, the by-product can exhibit an iron content of at least about 50 wt. %, at least about 60 wt. %, or greater. In other aspects. The by-product does not contain significant concentrations of impurities that might adversely affect the preparation of a ferrite or the resulting ferrite material. In one aspect, the iron containing by-product can comprise an iron oxide dust having a total iron concentration of about 68 wt. %. In another aspect, the iron containing by-product comprises Fe(II), Fe(III), Fe(II/III), or a combination thereof.

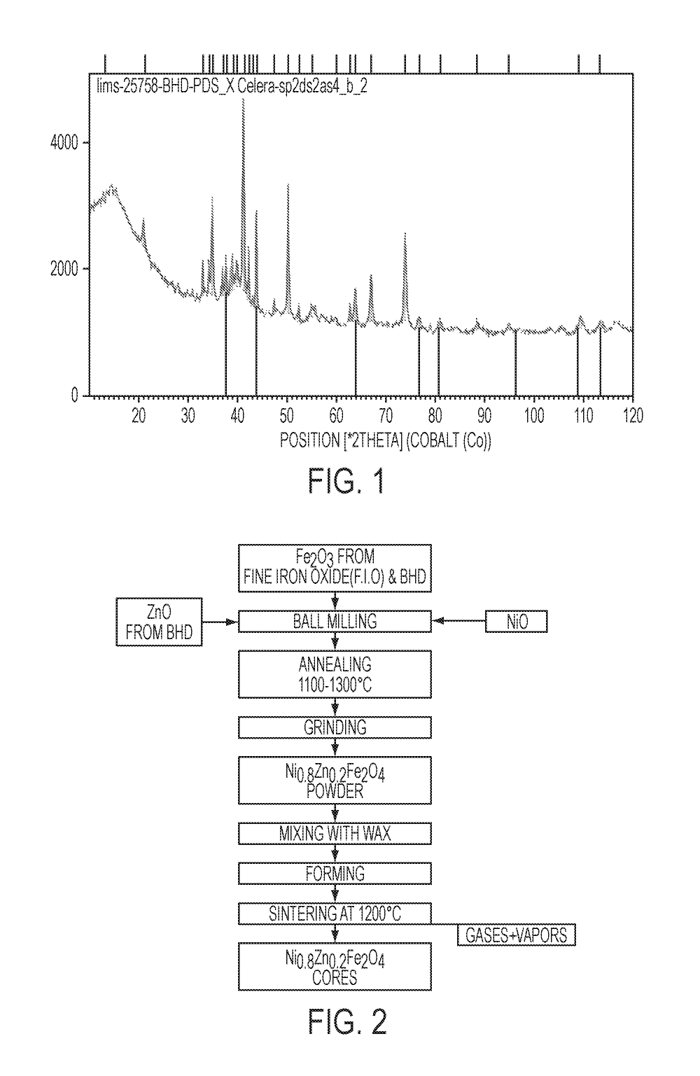

In another aspect, a bag house dust can comprise one or more metals and/or metal containing compounds that can be useful in preparing a ferrite material. In another aspect, the bag house dust, if used, does not contain significant concentrations of impurities that might adversely affect the preparation of a ferrite or the resulting ferrite material. In one aspect, a bag house dust can comprise one or more of Zn, Ca, K, Mn, Fe, or a combination thereof. In one aspect, a bag house dust can comprise, for example, from about 5 wt. % to about 70 wt. % iron, for example, about 5, 10, 15, 20, 25, 30, 35, 40, 45, 50, 55, 60, 65, or 70 wt. % iron, depending upon the specific source of the bag house dust. In another aspect, a bag house dust can comprise from about 20 wt. % to about 50 wt. % iron, for example, about 20, 25, 30, 35, 40, 45, or 50 wt. % iron. In another aspect, a bag house dust can comprise from about 25 wt. % to about 40 wt. % iron, for example, about 25, 30, 35, or 40 wt. % iron. In still another aspect, a bag house dust can comprise about 28 wt. % or about 35 wt. % iron. In still other aspects, a bag house dust can comprise iron in amounts less than 5 wt. % or greater than 70 wt. %, and the present invention is not intended to be limited to any particular iron concentration. An exemplary X-Ray Diffraction pattern for a bag house dust is illustrated in FIG. 1. Exemplary chemical compositions of such by-products are detailed in Table 1, below. In other aspects, the iron containing by-product can comprise other compositions typical in the steel industry, for example, and not specifically recited in Table 1.

TABLE 1
Exemplary Chemical Compositions of Iron Containing By-Products

| | Wt. % | | | | |
|---|---|---|---|---|---|
| | | | | | Bag |
| | Oxide fines | Oxide fines | Mill | | house |
| | 0-3 mm | 3-6 mm | scale | Slurry | dust |
| Fe_{2X} | 63.1 | 65.8 | 70.1 | 60.2 | 28.3 |
| Fe₃O₄² | 5.5 | 4.32 | 21.6 | 37.9 | 25.8 |
| Fe²⁺ | 2.6 | 0.85 | 46.5 | 12.8 | 9.1 |
| Fe¹ | | | 0.44 | 5.2 | |
| SiO₂ | 2.3 | 1.2 | 0.52 | 2.7 | 4.9 |
| CaO | 0.66 | 0.78 | 0.18 | 2.7 | 6.0 |
| MgO | 0.41 | 0.46 | 0.029 | 0.95 | 5.5 |
| Al₂O₅ | 0.81 | 0.33 | 0.084 | 1.6 | 0.84 |
| C | 0.22 | 0.06 | 0.21 | 1.8 | 1.2 |
| S | 0.05 | 0.02 | 0.02 | 0.03 | 0.45 |
| Na | | | | 0.028 | 3.6 |
| K | | | | <0.01 | 2.8 |
| Zn | | | | <0.01 | 15.8 |
| Cl⁻ | | | | 0.003 | 1.7 |
| F⁻ | | | | 0.069 | 0.0945 |
| H₂O_{crystal} [symbol] | | | | 3.0 | 2.4 |
| Loss of ignition | | | | 8.2 | 14.2 |

[symbol]

indicates data missing or illegible when filed

In another aspect, a fine iron oxide can comprise a composition such as that detailed in Table 2, below.

TABLE 2
Iron Oxide Composition as Determined by X-Ray Fluorescence

| Oxide | Conc. Wt. % | Element | Conc. Wt. % |
|---|---|---|---|
| C | 0.0772 | C | 0.42 |
| MgO | 0.093 | Mg | 0.056 |
| Al₂O₃ | 0.19 | Al | 0.1 |
| SiO₂ | 0.885 | Si | 0.414 |
| P₂O₅ | 0.205 | P | 0.0895 |
| S | 0.005 | S | 0.02 |
| K₂O | 0.014 | K | 0.012 |
| CaO | 1.02 | Ca | 0.729 |
| TiO₂ | 0.0396 | Ti | 0.0237 |
| MnO | 0.0664 | Mn | 0.0514 |
| Fe₂O₃ | Balance | Fe | Balance |
| ZnO | 0.013 | Zn | 0.0104 |

In another aspect, the composition of an exemplary bag house dust, as determined by X-Ray Fluorescence is detailed in Table 3, below.

TABLE 3
X-Ray Fluorescence Analysis of Bag House Dust

| Compound | Conc. Wt. % | Element | Conc. Wt. % |
|---|---|---|---|
| C | 1.9803 | C | 1.9800 |
| Na₂O | 0.3245 | Na | 0.2390 |
| MgO | 3.1500 | Mg | 1.9000 |
| Al₂O₃ | 0.2425 | Al | 0.1280 |
| SiO₂ | 1.4600 | Si | 0.6825 |
| P₂O₅ | 0.3220 | P | 0.1405 |
| S | 0.1399 | S | 0.2070 |
| Cl | 0.7240 | Cl | 0.7235 |
| K₂O | 3.9495 | K | 3.2765 |
| CaO | 21.6850 | Ca | 15.4900 |
| TiO₂ | 0.0722 | Ti | 0.0433 |
| V₂O₅ | 0.0755 | V | 0.0423 |
| Cr₂O₃ | 0.0750 | Cr | 0.0513 |
| MnO | 2.0825 | Mn | 1.6120 |
| Fe₃O₄/Fe₂O₃ | Balance | Fe | Balance |
| CuO | 0.0814 | Cu | 0.0651 |
| ZnO | 11.9200 | Zn | 9.5700 |
| Br | 0.0228 | Br | 0.0227 |
| Rb₂O | 0.0267 | Rb | 0.0244 |
| SrO | 0.0188 | Sr | 0.0159 |
| PbO | 0.8010 | Pb | 0.7435 |

In other aspects, the particle size of a by-product can vary, depending on the source of the by-product. In various aspects, the particle size of an iron containing by-product can be about 10 mm or less, about 8 mm or less, 6 mm or less, about 5 mm or less, about 4 mm or less, or about 2 mm or less. In another aspect, a bag house dust can have a particle size of about 0.3 mm or less, about 0.2 mm or less, about 0.1 mm or less, or about 0.05 mm or less. Exemplary particle sizes are detailed in Table 4, below. It should be noted that particle sizes are typically a distributional property and that a sample having an average particle size can typically comprise a range of individual particle sizes.

TABLE 4
Exemplary Particle Distributions for By-Products

| | Undersize, % | | | | |
|---|---|---|---|---|---|
| Screen | | | | | Bag |
| Size | Oxide pellet | Oxide pellet | Mill | | house |
| (mm) | fines (0-3 mm) | fines (3-6 mm) | scale | Slurry | dust |
| 8.00 | | 100.00 | | | |
| 6.73 | | 99.40 | | | |
| 6.00 | 100.00 | 95.73 | 100.00 | | |
| 4.76 | 99.65 | 53.93 | 99.38 | | |
| 3.35 | 96.09 | 4.96 | 96.12 | | |
| 2.36 | 75.11 | 2.65 | 92.46 | 100.00 | |
| 1.70 | 54.62 | 2.58 | 83.93 | | |
| 1.18 | 47.36 | | 74.66 | | |
| 0.850 | 43.69 | | 65.13 | | |
| 0.600 | 40.71 | | 56.37 | | |
| 0.500 | | | | 98.69 | |
| 0.425 | 39.11 | | 47.94 | | |
| 0.300 | 37.74 | | 38.56 | | |
| 0.212 | 36.22 | | 29.52 | 96.28 | 97.75 |
| 0.150 | 34.98 | | 21.58 | 95.21 | 94.80 |
| 0.106 | | | | 93.73 | 92.94 |
| 0.075 | 32.79 | | 11.41 | 92.09 | 92.01 |
| 0.053 | | | | 90.02 | 88.60 |
| 0.044 | | | | 87.03 | 85.05 |
| 0.038 | 27.31 | | 6.42 | 84.93 | 81.01 |
| 0.020 | | | | 63.77 | 67.93 |
| 0.010 | | | | 44.68 | 61.48 |
| 0.005 | | | | 31.60 | 56.11 |
| 0.003 | | | | 23.00 | 49.66 |
| 0.002 | | | | 16.63 | 42.41 |
| 0.001 | | | | 7.21 | 26.67 |
| 0.0005 | | | | 1.56 | 11.49 |

If a separate metal oxide component is used, each of the one or more metal oxide components can comprise any metal oxide suitable for use in preparing a soft ferrite. In one aspect, a metal oxide can comprise a nickel oxide. In another aspect, a metal oxide can comprise a magnesium oxide. In yet another aspect, a metal oxide can comprise a zinc oxide. In another aspect, a metal oxide can comprise two or more individual metal oxides or a mixture thereof. The purity of a metal oxide can vary, provided that such a metal oxide is suitable for use in preparing a soft ferrite as described herein. In one aspect, a metal oxide is pure or substantially pure. In another aspect, the metal oxide can be analytical grade. In one aspect, the purity of a metal oxide is at least about 80%, at least about 85%, at least about 90%, at least about 95%, or greater. In another aspect, the purity of a metal oxide is at least about 96%, at least about 97%, at least about 98%, at least about 99%, at least about 99.5%, or greater.

The size and composition of a separate metal oxide component or mixture of metal oxides can vary, for example, depending on the desired properties of the resulting soft ferrite. Metal oxides are commercially available and one of skill in the art, in possession of this disclosure, could readily select appropriate metal oxides for use in the methods described herein.

In one aspect, the ferrite composition of the present disclosure can comprise the formula Ni₁₋ₓZnₓFe₂O₄, wherein x can vary. In one aspect, x is 0.2, such that the ferrite composition is Ni_{0.8}Zn_{0.2}Fe₂O₄. In another aspect, the ferrite composition can be represented by the ratio of nickel and zinc to iron, for example, (0.8 M Ni+0.2 M Zn):Fe, wherein the ratio is 1:2, 1:1.9, or 1:1.8.

In one aspect, a bag house dust can provide a source of iron and zinc, and a fine iron oxide dust can be used to provide any additional amounts of iron that may be necessary to reach the desired stoichiometry. For example, a quantity of bag house dust necessary to provide a desired amount of zinc can be selected. The amount of iron present in the selected amount of bag house dust can be calculated, and the difference between the iron in the bag house dust and that needed to achieve the desired stoichiometry can be provided by a by-product fine iron oxide dust.

In one aspect, the raw materials, for example, a nickel oxide, a fine iron oxide dust, and a bag house dust can be contacted. In another aspect, the raw materials can be mixed so as to achieve a uniform or substantially uniform mixture. It should be noted that the particular combination of by-product iron oxide, by-product bag house dust, and any additional metal oxides can vary depending upon the specific compositions of the raw materials and the desired stoichiometry of a resulting ferrite material.

An exemplary process diagram for synthesizing a nickel zinc ferrite from a fine iron oxide and bag house dust is illustrated in FIG. 2. It should be noted that this process diagram is exemplary and that the present invention is not limited to any particular process steps or combination of steps.

In another aspect, the raw materials (e.g., iron oxide, bag house dust, and nickel oxide) or a portion thereof can optionally be milled and/or ground prior to contacting. In another aspect, the iron containing by-product can be finely ground prior to mixing with the bag house dust, nickel oxide, and/or any other components.

After contacting, the raw materials can be mixed, for example, in a ball mill for about a period of time, for example, about 2 hours. The mixture can then be dried, for example, at about 100° C. for a period of time, for example, from about 3 hours to about 48 hours, for example, about 3, 4, 5, 8, 10, 12, 14, 16, 18, 20, 24, 28, 32, 36, 40, 44, or 48 hours, or overnight.

The mixture of raw materials can then be calcined to form a ferrite material, such as, for example, a nickel zinc ferrite. In one aspect, the mixture of raw materials can be heated at a rate of about 10° C./min in a static air atmosphere up to a desired annealing temperature. In various aspects, the annealing temperature can range from about 1,000° C. to about 1,500° C., for example, about 1,000° C., about 1,100° C., about 1,200° C., about 1,300° C., about 1,400° C., or about 1,500° C. Once the desired annealing temperature is reached, the calcined mixture of raw materials can be held at the annealing temperature for a period of time, for example, about 2 hours.

In one aspect, the mixture of raw materials and/or a portion thereof is not subjected to one or more of an oxidation step or a compacting step prior to calcining. In another aspect, the mixture of raw materials and/or a portion thereof is not subjected to an oxidation step or a compacting step prior to calcining.

In general, the amount of zinc present in a nickel zinc ferrite material can affect the formation of the resulting material. At an annealing temperature of about 1,100° C., the formation of crystalline single phase nickel zinc ferrite increases with a corresponding increase in the zinc ion content.

Depending on the annealing time and temperature, the resulting ferrite material can exhibit impurities, such as, for example α-Fe₂O₃. In one aspect, such impurities can be present when annealing temperatures of 1,100° C. or less are utilized. In another aspect, impurities, such as, for example, calcium oxide, can be present in a bag house dust and thus, in the ferrite material. X-Ray Diffraction can be used to examine the composition and/or purity of a resulting ferrite material.

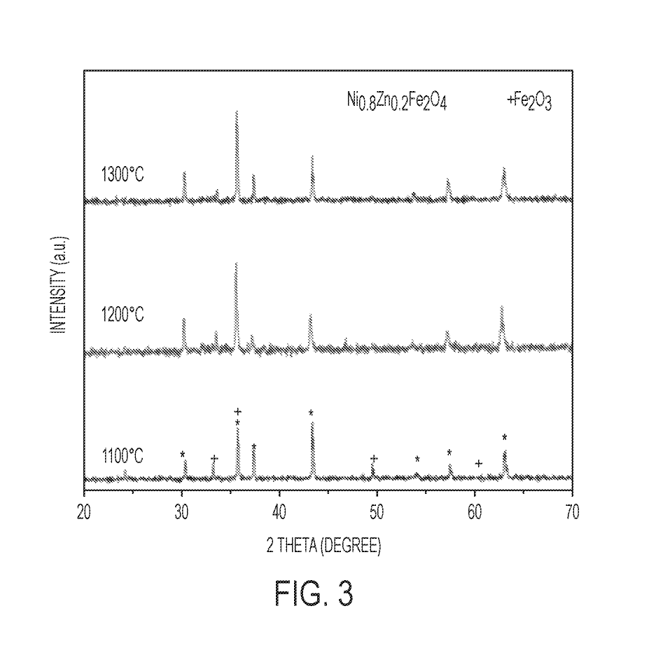

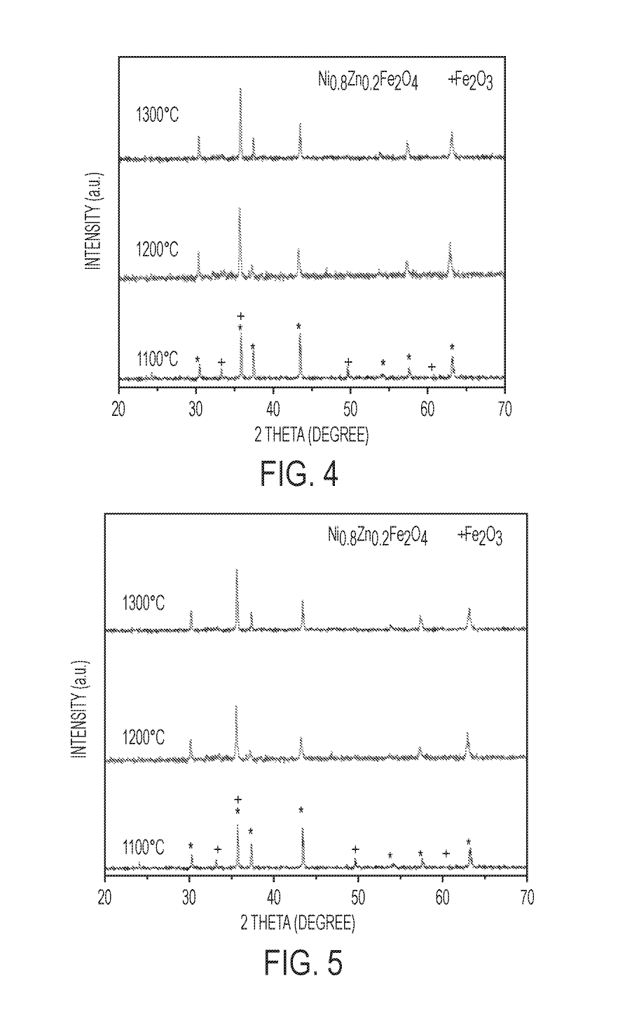

In another aspect, the amount of iron in one or more raw material components can affect the formation of the resulting ferrite material. In one aspect, formation of a crystalline, single phase Ni_{0.8}Zn_{0.2}Fe₂O₄ material can be enhanced at lower iron concentrations and/or at increased annealing temperatures. In one aspect, a Ni_{0.8}Zn_{0.2}Fe₂O₄ material can be prepared using a molar ratio of nickel and zinc to iron of 1:1.9. In another aspect, a Ni_{0.8}Zn_{0.2}Fe₂O₄ material can be prepared at an annealing temperature of 1,300° C. Exemplary XRD patterns of nickel zinc ferrite materials prepared using fine iron oxide and bag house dust are illustrated in FIGS. 3-5.

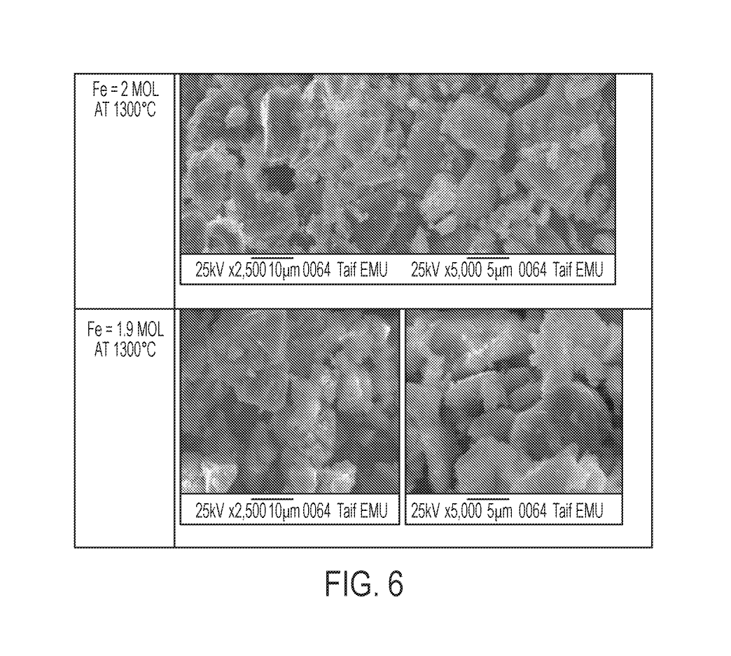

The microstructure of a nickel zinc ferrite material prepared from a fine iron oxide and bag house dust, in accordance with the methods of the present disclosure, is illustrated in FIG. 6. In general, such materials can exhibit an irregular crystalline structure due to the presence of impurities in, for example, a bag house dust. In one aspect, there can be an increase in grain size of the resulting ferrite material with a corresponding increase in the annealing temperature. For example, materials annealed at 1,200° C. can exhibit a clear crystalline structure with homogeneous microstructure and substantially uniform size distribution. In another aspect, such materials can also exhibit intragranular pores (i.e., grain boundary pores) resulting from, for example, discontinuous grain growth. For materials annealed at temperatures of about 1,300° C. and above, abnormal grain growth and closed pores can be observed. For example, a plurality of grains can be at least partially fused so as to form a large grain up to several micrometers in size. Porosity in a ferrite material can result from intragranular pores and intergranular pores. Intergranular porosity can depend upon the grain size of the material. At higher annealing temperatures, such as, for example, about 1,300° C., pores can be left and trapped (i.e., intragranular pores) due to rapidly moving grain boundaries. Thus, in one aspect, quick and/or discontinuous grain growth can hinder migration of pores to grain boundaries, resulting in the formation of intragranular pores. Such intragranular pores can, in various aspects, adversely affect magnetic properties of the resulting ferrite material. In another aspect, magnetic properties, such as, for example, coercivety and saturation magnetization can be dependent upon grain size.

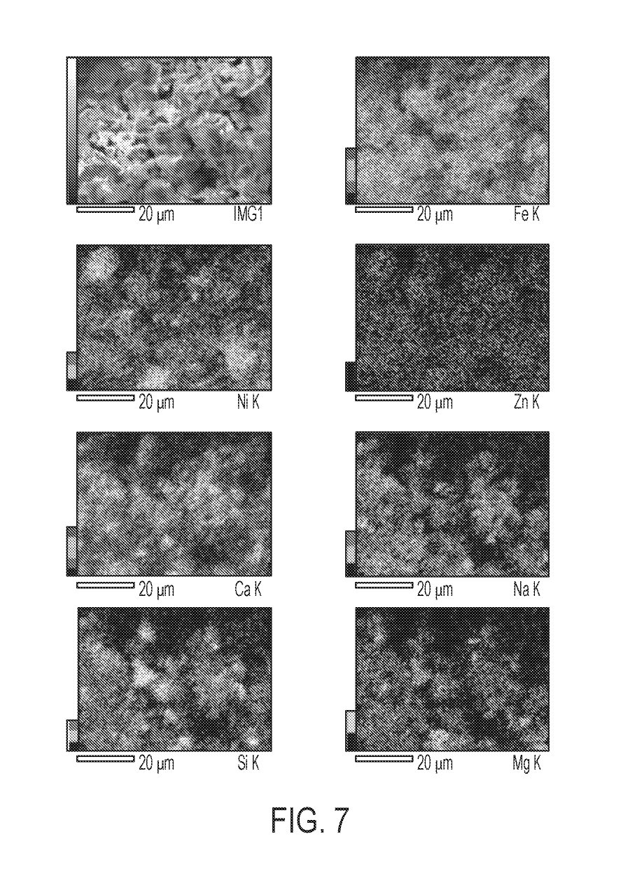

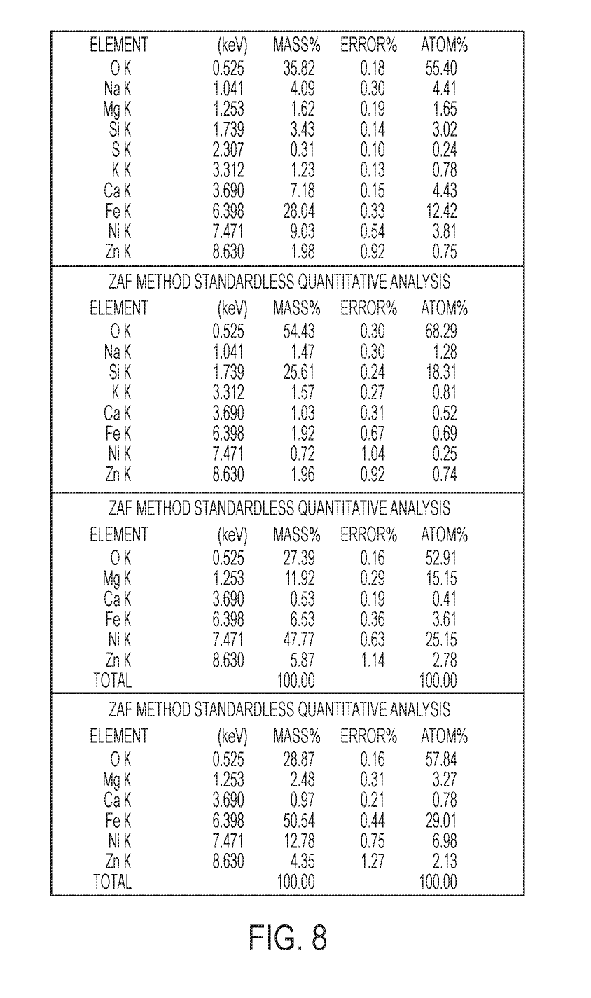

In one aspect, the distribution of elements (i.e., Fe, Ni, Zn, O, and impurities such as Na and Ca) within a ferrite material can be determined by, for example, energy dispersive x-ray analysis (EDX). In one aspect, the distribution of Fe, Ni, Zn, and O in a ferrite material can be uniform or substantially uniform, such that the resulting ferrite material exhibits a homogeneous microstructure. FIGS. 7 and 8 illustrate a microstructure map and spot analysis data for a nickel zinc ferrite material prepared with a molar ratio of nickel and zinc to iron [0.8 M Ni+0.2 M Zn):Fe] or 1:1.9 and annealed at 1,300° C.

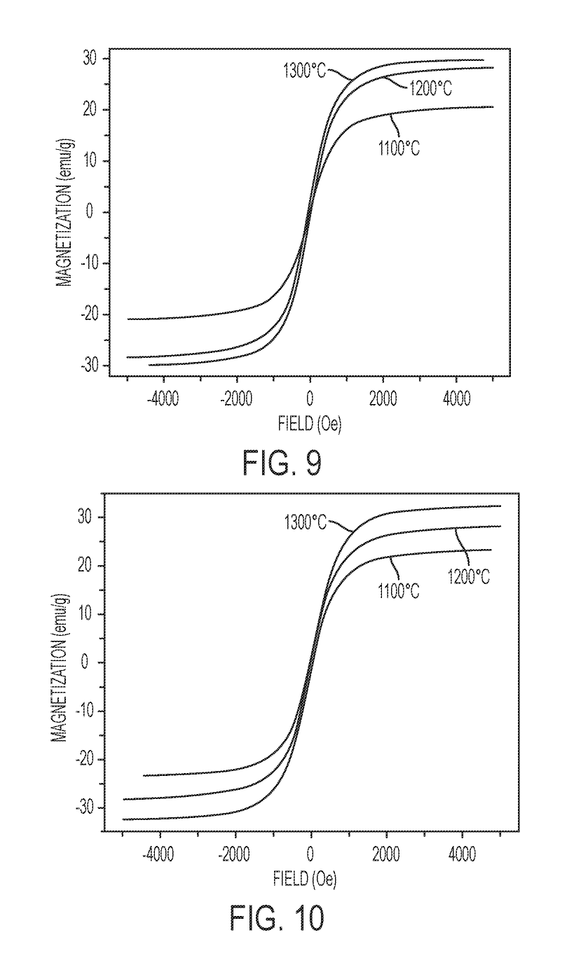

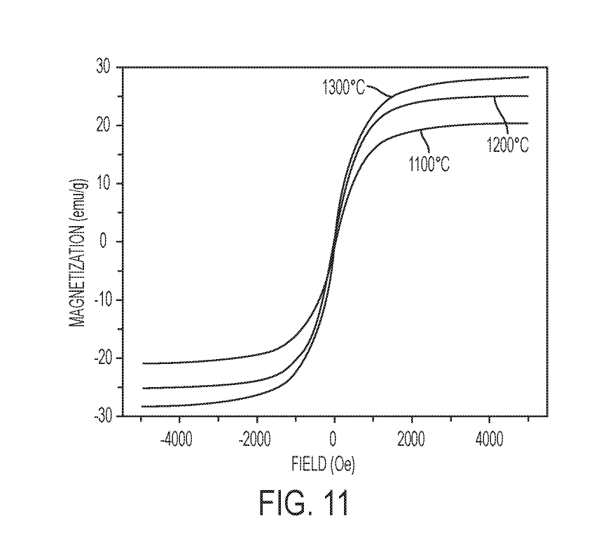

In another aspect, the resulting ferrite materials can be magnetized at room temperature under an applied field of, for example, 5 KOe, wherein hysteresis loops can be obtained. Exemplary plots of magnetization (M) as a function of the applied field (H) for the nickel zinc ferrite materials are illustrated in FIGS. 9-11. In general, a nickel zinc ferrite can be a soft magnetic material due to, for example, inherent low coercivity. In another aspect, the magnetic properties of a nickel zinc ferrite can be dependent upon, for example, the annealing temperature and/or zinc ion concentration.

In one aspect, the saturation magnetization of a nickel zinc ferrite can be increased by raising the annealing temperature, for example, from about 1,100° C. to about 1,300° C. Such an increase can, in various aspects, be attributed to an increase in phase formation, grain size, and/or crystallite size. In another aspect, the saturation magnetization of a nickel zinc ferrite material can increase with a corresponding decrease in iron concentration up to a molar ratio of nickel and zinc to iron of 1:1.9. In one aspect a nickel zinc ferrite prepared in accordance with the methods described herein can exhibit a saturation magnetization of at least about 20 emu/g, at least about 25 emu/g, at least about 28 emu/g, at least about 29 emu/g, at least about 30 emu/g, at least about 31 emu/g, at least about 32 emu/g, at least about 33 emu/g, or higher. In one aspect, such saturation magnetization values can be achieved at a molar ratio of nickel and zinc to iron of about 1:1.9 and at an annealing temperature of about 1,300° C. In another aspect, when the iron content is decreased such that the molar ratio of nickel and zinc to iron is about 1:1.8, the saturation magnetization can decrease. While not wishing to be bound by theory, changes in magnetic properties are believed to be due to the influence of the cationic stoichiometry and their occupancy in the specific sites.

In other aspects, a ferrite of the present invention or a composition comprising a ferrite of the present invention can be used in one or more of power electronics, ferrite antennas, magnetic recording heads, magnetic intensifiers, data storage cores, filter inductors, wideband transformers, power/current transformers, magnetic regulators, driver transformers, wave filters, cable EMI, or a combination thereof. In one aspect, the inventive ferrite can comprise a core material for one or more of the devices and/or applications described above. In another aspect, an article of manufacture can comprise the ferrite of the present invention.

The methods and compositions of the present disclosure can be described in a number of exemplary and non-limiting aspects, as described below.

Aspect 1: A method of synthesis soft cubic ferrites of a general formula M^{a}₍₁₋ᵢ₎M^{b}ᵢFe₂O₄ comprising:
a) contacting:
   i. an iron source;
   ii. a first metal oxide having the general formula M^{b}ₓO_{y}; and
   iii. a second metal oxide having the general formula M^{a}ₓO_{y};
wherein metals M^{a} and M^{b} comprise nickel, magnesium, zinc, or a combination thereof; and
wherein the stoichiometric ratio of M^{a}/M^{b} is equal to i/(1−i);
b) mixing the iron source, the first metal oxide, and the second metal oxide to form a mixture, wherein the stoichiometric ratio of (M^{a}+M^{b}) to iron is from greater than zero to about 2; and then
c) calcining the mixture at the temperature range from about 1000° C. to about 1500° C. in a static air atmosphere;
wherein the mixture is not subjected to an oxidation step or a reduction step prior calcining.

Aspect 2: The method of aspect 1, wherein the metal M^{a} is nickel.

Aspect 3: The method of aspect 1, wherein the metal M^{b} is zinc.

Aspect 4: The method of aspect 1, wherein i is in a range from about 0.1 to about 0.4

Aspect 5: The method of aspect 1, wherein the iron source comprises iron containing by-products of iron ore processing.

Aspect 6: The method of aspect 5, wherein the iron containing by-products comprise iron oxide dust, bag house dust (BHD), or a combination thereof.

Aspect 7: The method of aspect 6, wherein the iron source comprises oxides of Fe(II), Fe(III), Fe(II/III), or a combination thereof.

Aspect 8: The method of aspect 6, wherein the iron oxide dust comprises at least 68 weight % of iron.

Aspect 9: The method of aspect 6, wherein the bag house dust comprises at least 35 weight % of iron.

Aspect 10: The method of aspect 1, wherein the first metal oxide comprises pure first metal oxide, bag house dust, or a combination thereof.

Aspect 11: The method of aspect 10, wherein the bag house dust comprises at least 11.92 wt % of the first metal oxide.

Aspect 12: The method of any of aspects 1-11, wherein the iron oxide dust and/or bag house dust are ground prior to contacting.

Aspect 13: The method of any of aspects 1-12, wherein contacting is performed for at least 2 hours.

Aspect 14: The method of any of aspects 1-13, further comprising drying the mixture prior to calcining.

Aspect 15: The method of aspect 14, wherein drying is performed at a temperature of at least about 100° C. for a period of time from about 3 to about 48 hours.

Aspect 16: The method of aspect 1, wherein the mole ratio of ((1−i)M²+iM¹)/Fe is about 1/2.

Aspect 17: The method of aspect 1, wherein the mole ratio of ((1−i)M²+iM¹)/Fe is about 1/1.9.

Aspect 18: The method of aspect 1, wherein the mole ratio of ((1−i)M²+iM¹)/Fe is about 1/1.8.

Aspect 19: The method of aspect 1, wherein calcining is performed at a temperature of about 1200° C.

Aspect 20: The method of aspect 1, wherein calcining is performed at a temperature of about 1300° C.

Aspect 21: The method of aspect 1, wherein calcining comprises heating at a rate of about 10° C./min.

Aspect 22: A Ni₍₁₋ᵢ₎ZnᵢFe₂O₄ ferrite prepared by the method of any of aspects 1-21.

Aspect 23: The Ni₍₁₋ᵢ₎ZnᵢFe₂O₄ ferrite of aspect 22, wherein i is in the range of from about 0.1 to about 0.4.

Aspect 24: The Ni₍₁₋ᵢ₎ZnᵢFe₂O₄ ferrite of aspect 22, wherein i is 0.2.

Aspect 25: The Ni₍₁₋ᵢ₎ZnᵢFe₂O₄ ferrite of aspect 24, wherein a mole ratio of ((1−i)Ni+iZn)/Fe is 1/1.9.

Aspect 26: The Ni₍₁₋ᵢ₎ZnᵢFe₂O₄ ferrite of aspect 24, wherein a mole ratio of ((1−i)Ni+iZn)/Fe is 1/1.8.

Aspect 27: The Ni₍₁₋ᵢ₎ZnᵢFe₂O₄ ferrite of aspect 25 or 26, comprising a single Ni₍₁₋ᵢ₎ZnᵢFe₂O₄ phase.

Aspect 28: The Ni₍₁₋ᵢ₎ZnᵢFe₂O₄ ferrite of claim 25, wherein the Ni₍₁₋ᵢ₎ZnᵢFe₂O₄ ferrite exhibits a maximum saturation magnetization of at least 20 emu/g.

Aspect 29: The Ni₍₁₋ᵢ₎ZnᵢFe₂O₄ ferrite of aspect 25, wherein the Ni₍₁₋ᵢ₎ZnᵢFe₂O₄ ferrite exhibits a maximum saturation magnetization of at least 25 emu/g.

Aspect 30: The Ni₍₁₋ᵢ₎ZnᵢFe₂O₄ ferrite of aspect 25, wherein the Ni₍₁₋ᵢ₎ZnᵢFe₂O₄ ferrite exhibits a maximum saturation magnetization of at least 30 emu/g.

Aspect 31: A composition comprising the ferrite of any of aspects 22-30.

Aspect 32: An article of manufacture comprising the ferrite of any of aspects 22-30.

Aspect 33: The composition of aspect 31, comprising core materials for power electronics, ferrite antennas, magnetic recording heads, magnetic intensifiers, cores for data storage, filter inductors, wideband transformers, power/current transformers, magnetic regulators, driver transformers, wave filters, or cable EMI.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1

In a first example, exemplary formulations for preparing a nickel zinc ferrite from a by-product fine iron oxide and a by-product bag house dust are described.

Formulation A: Preparation of Ni_{0.8}Zn_{0.2}Fe₂O₄ having a molar ratio of (0.8 M Ni+0.2 M Zn):Fe of 1:2

0.8 mol NiO+0.2 mol ZnO+1 mol Fe₂O₃→Ni_{0.8}Zn_{0.2}Fe₂O₄

To prepare 1 mole of Ni_{0.8}Zn_{0.2}Fe₂O₄, 16.28 g of ZnO are needed. 100 g of a bag house dust sample contain 11.92 g of ZnO. Thus, 134.23 g of bag house dust are needed to provide the desired quantity of ZnO. The bag house dust also contains 55.6 wt. % of Fe₂O₃. Thus, the 134.23 g of bag house dust contains 74.69 g of Fe₂O₃. Since 160 g of Fe₂O₃ are needed, an additional 85.31 g of Fe₂O₃ can be provided in a fine iron oxide dust.

Formulation B: Preparation of Ni_{0.8}Zn_{0.2}Fe₂O₄ having a molar ratio of (0.8 M Ni+0.2 M Zn):Fe of 1:1.9

0.8 mol NiO+0.2 mol ZnO+0.95 mol Fe₂O₃→Ni_{0.8}Zn_{0.2}Fe₂O₄

To prepare 1 mole of Ni_{0.8}Zn_{0.2}Fe₂O₄, 16.28 g of ZnO are needed. 100 g of a bag house dust sample contain 11.92 g of ZnO. Thus, 134.23 g of bag house dust are needed to provide the desired quantity of ZnO. The bag house dust also contains 55.6 wt. % of Fe₂O₃. Thus, the 134.23 g of bag house dust contains 74.69 g of Fe₂O₃. Since 152 g of Fe₂O₃ are needed, an additional 77.31 g of Fe₂O₃ can be provided in a fine iron oxide dust.

Formulation C: Preparation of Ni_{0.8}Zn_{0.2}Fe₂O₄ having a molar ratio of (0.8 M Ni+0.2 M Zn):Fe of 1:1.8

0.8 mol NiO+0.2 mol ZnO+0.90 mol Fe₂O₃→Ni_{0.8}Zn_{0.2}Fe₂O₄

To prepare 1 mole of Ni_{0.8}Zn_{0.2}Fe₂O₄, 16.28 g of ZnO are needed. 100 g of a bag house dust sample contain 11.92 g of ZnO. Thus, 134.23 g of bag house dust are needed to provide the desired quantity of ZnO. The bag house dust also contains 55.6 wt. % of Fe₂O₃. Thus, the 134.23 g of bag house dust contains 74.69 g of Fe₂O₃. Since 144 g of Fe₂O₃ are needed, an additional 69.31 g of Fe₂O₃ can be provided in a fine iron oxide dust.

### 2. Example 2

In a second example, a by-product fine iron oxide sample (Fe₂O₃) with about 68% total iron was finely ground and thoroughly mixed with a stoichiometric amounts of a nickel oxide and a bag house dust as detailed in Example 1. Ferrite samples having the formula Ni—_{0.8}Zn_{0.2}Fe₂O₄ were prepared, wherein the molar ratio of nickel and zinc to iron ranged from 1:2 to 1:1.8. The pre-calculated stoichiometric ratios of fine iron oxide, nickel oxide, and bag house dust were mixed in a ball for 2 h and then dried at 100° C. overnight. For the formation of the Ni−Zn ferrite phase, the dried precursors were calcined at a rate of 10° C./min in static air atmosphere up to the required annealed temperature and maintained at the temperature for the annealing time in the muffle furnace. The effect of annealing temperature (1,100, 1,200, and 1,300° C.) on the formation of Ni—Zn ferrite was studied.

The crystalline phases present in the different samples were identified by X-ray diffraction (XRD) in the range 2θ from 10° to 80°. The ferrites particle morphologies were observed by scanning electron microscope (SEM, JSM-5400). The magnetic properties of the ferrites were measured at room temperature using a vibrating sample magnetometer (VSM; 9600-1 LDJ, USA) in a maximum applied field of 5 kOe. From the obtained hysteresis loops, the saturation magnetization (Ms), Remnant Magnetization (Mr) and Coercivety (Hc) were determined.

### 3. Example 3

In a third example, the resulting nickel ferrite materials were magnetized. Magnetization of the produced nickel ferrite powders was performed at room temperature under an applied field of 5 KOe and the hysteresis loops of the ferrite powders were obtained. Plots of magnetization (M) as a function of applied field (H) per Mg/Fe mole ratio and annealing temperature were shown in FIGS. 9-11. In general, the nickel zinc ferrite was a soft magnetic material due to the deviation from rectangular form and the low coercivity and the magnetic properties of the prepared nickel zinc ferrites are dependent on the annealing temperature and the iron concentration. Decreasing the iron concentration (e.g., molar ratio of nickel and zinc to iron) from 1:2 to 1:1.9 can result in an increase in saturation magnetization up to, for example, 33 emu/g. Further decreases in the iron concentration to a molar ratio of 1:1.8 resulted in a decrease in saturation magnetization.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of synthesis soft cubic ferrites of a general formula M^{a}₍₁₋ᵢ₎M^{b}ᵢFe₂O₄ comprising:
a) contacting:
i. an iron source;
ii. a first metal oxide having the general formula M^{b}ₓO_{y}; and
iii. a second metal oxide having the general formula M^{a}ₓO_{y};
wherein metals M^{a} and M^{b} comprise nickel, magnesium, zinc, or a combination thereof; and
wherein the stoichiometric ratio of M^{a}/M^{b} is equal to i/(1−i);
b) mixing the iron source, the first metal oxide, and the second metal oxide to form a mixture, wherein the stoichiometric ratio of (M^{a}+M^{b}) to iron is from greater than zero to about 2; and then
c) calcining the mixture at the temperature range from about 1000° C. to about 1500° C. in a static air atmosphere;
wherein the mixture is not subjected to an oxidation step or a reduction step prior calcining.

2. The method of claim 1, wherein the metal M^{a} is nickel.

3. The method of claim 1, wherein the metal M^{b} is zinc.

4. The method of claim 1, wherein i is in a range from about 0.1 to about 0.4

5. The method of claim 1, wherein the iron source comprises iron containing by-products of iron ore processing.

6. The method of claim 5, wherein the iron containing by-products comprise iron oxide dust, bag house dust (BHD), or a combination thereof.

7. The method of claim 6, wherein the iron source comprises oxides of Fe(II), Fe(III), Fe(II/III), or a combination thereof.

8. The method of claim 6, wherein the iron oxide dust comprises at least 35 weight % or iron to at least 68 weight % of iron.

9. (canceled)

10. The method of claim 1, wherein the first metal oxide comprises pure first metal oxide, bag house dust, or a combination thereof.

11-13. (canceled)

14. The method of claim 1, further comprising drying the mixture prior to calcining.

15. (canceled)

16. The method of claim 1, wherein the mole ratio of ((1−i)M²+iM¹)/Fe is about 1:2, 1:1.9 or 1:1.8.

17. (canceled)

18. (canceled)

19. The method of claim 1, wherein calcining is performed at a temperature of about 1200° C.

20. (canceled)

21. (canceled)

22. A ferrite, wherein the ferrite comprises Ni₍₁₋ᵢ₎ZnᵢFe₂O₄ ferrite prepared by the method of claim 1.

23. (canceled)

24. The Ni₍₁₋ᵢ₎ZnᵢFe₂O₄ ferrite of claim 22, wherein i is 0.2.

25. The Ni₍₁₋ᵢ₎ZnᵢFe₂O₄ ferrite of claim 24, wherein a mole ratio of ((1−i)Ni+iZn)/Fe is 1:1.9 or 1:1.8.

26. (canceled)

27. The Ni₍₁₋ᵢ₎ZnᵢFe₂O₄ ferrite of claim 25, comprising a single Ni₍₁₋ᵢ₎ZnᵢFe₂O₄ phase.

28. The Ni₍₁₋ᵢ₎ZnᵢFe₂O₄ ferrite of claim 25, wherein the Ni₍₁₋ᵢ₎ZnᵢFe₂O₄ ferrite exhibits a maximum saturation magnetization of at least 20 emu/g, at least 25 emu/g or at least 30 emu/g.

29. (canceled)

30. (canceled)

31. A composition comprising the ferrite of claim 22.

32. An article of manufacture comprising the ferrite of claim 22.

33. The composition of claim 31, comprising core materials for power electronics, ferrite antennas, magnetic recording heads, magnetic intensifiers, cores for data storage, filter inductors, wideband transformers, power/current transformers, magnetic regulators, driver transformers, wave filters, or cable EMI.
